(19) United States
(12) Patent Application Publication
(10) Pub. No.: US 2008/0254292 A1
(43) Pub. Date: Oct. 16, 2008

(54) PVC fibers and method of manufacture

(75) Inventor: Hwan Chul Kim, Chonju (KR)

Correspondence Address: Husch Blackwell Sanders, LLP;Welsh & Katz, 120 S RIVERSIDE PLAZA, 22ND FLOOR, CHICAGO, IL, 60606, US

(73) Assignee: TY, INC., Westmont, IL (US)

(21) Appl. No.: 11/786,591

(22) Filed: Apr. 12, 2007

(51) Int. Cl. B32B 27/02; B29C 47/00

(52) U.S. Cl. 428/391; 264/176.1

(57) ABSTRACT

Improved PVC filaments for use as wig material for toy dolls are described. PVC resin may be mixed with a stabilizing agent, lubricants, and a processing aid and pounded into PVC resin pellets. The PVC resin pellets may be subsequently spun or extruded in a conventional spin-draw machine. Undrawn PVC filaments are oil-coated and drawn at differential temperatures on a plurality of roller sets prior to heat-setting and being wound on a take-up unit.

### FIELD OF THE INVENTION

This invention relates to poly-vinyl chloride fibers and a method of manufacturing the same.

### BACKGROUND OF THE INVENTION

PVC filaments may be prepared for use as wig material for toy dolls. Manufacturers have found it difficult to manufacture PVC filaments for this purpose that reproduce and mimic natural looking hair. PVC filaments currently in use are often difficult to curl, have a tendency to tangle, are not easily combed, or do not possess sheen emulating natural hair.

Previously, PVC filaments for wigs and toy hair have been manufactured using one of two spinning processes. A wet spinning process utilizes a solvent to dissolve a PVC resin or PVC pellets. Once the resin has been dissolved, the solution is spun into fibers. Thereafter, the solvent is evaporated. Wet spinning processes have a variety of disadvantages. Once the solvent has been evaporated, fibers formed by the wet spinning process are often warped and uneven, vary in fiber strength, are not reproducible, contain solvent voids, and do not have uniform luster.

The second common process of producing PVC filaments for toy hair is a melt spinning process. The melt spinning process involves melting PVC resin or PVC pellets by heating. Once the PVC material has been melted, it is extruded from a spinnerette, drawn on a series of godets and subsequently cooled. In the melt spinning process, a stabilizing agent may be added to the PVC polymer. Examples of stabilizing agents known in the art are cadmium (Cd), lead (Pb) and tin (Sn) compounds. Recently an inorganic stabilizing agent such as hydrotalcite are known to be beneficial when added to the PVC polymer. As previously described, the PVC pellets are fed into a spinning machine to prepare undrawn filaments through a melt spinning process. The undrawn filaments are drawn and heat-treated with a drawing machine to prepare PVC fibers that are suitable for use as wig material for toy dolls.

In some cases it is desirable to carry out a powder spinning process in a spinning machine. In the powder spinning process, PVC powder and the desired additives are fed into a spinning machine and undrawn filaments prepared. The undrawn filaments are then drawn and heat-treated with a drawing machine as previously described to obtain PVC fibers suitable for use as wig material for toy dolls.

Conventional processes for the production of PVC filaments for toy hair, however, have not been widely regarded as suitable for the purpose. PVC filaments manufactured in accordance with the conventional processes often lack sufficient and consistent physical properties desired for use as toy hair. The PVC filaments for toy hair should have excellent curl formability, brightness, soft touch, durability, and compatibility. The conventional PVC filaments for wig hair are prepared through several separate steps such as preparation of undrawn filaments, a drawing step, heat setting step etc., which is considered to cause degradation of filament quality. In particular, the drawing and heat setting steps affect the evenness of the filaments and increase the elongation of the filaments, thereby creating an unattractive appearance of the filaments, tangling of the filaments, rough texture and poor combability.

Accordingly, it is desirable to develop new processes of preparing PVC filaments suitable for using as wig material in toy dolls that have uniform evenness, reduced elongation and shrinkage, excellent durability, smoothness and sheen, while still possessing excellent formability such that the fibers do not tangle and are easily combed.

### SUMMARY OF THE INVENTION

It is an object of the present invention to provide a method for producing improved PVC filaments suitable for use in toy dolls.

Accordingly, the foregoing objectives are provided for where PVC pellets comprised of PVC resin, a suitable stabilizing agent, lubricant, and a processing aid are prepared. In a preferred method, the PVC pellets are comprised of 100 parts by weight of PVC resin, 1 to 5 parts by weight of a stabilizing agent, 0.3 to 3.0 parts by weight of a lubricant, and 0.1 to 3.0 parts by weight of a processing aid.

The PVC pellets prepared according the present invention are spun or extruded into undrawn filaments in a conventional spin-draw machine, an example of which is described in U.S. Pat. No. 2,822,237. Following extrusion, the filaments are oil-treated with a silicone oil comprising OH-terminated polydimethyl siloxane, an amino-modified polydimethyl siloxane, and an epoxy silicone. Following oil-treatment, the fibers are drawn and cooled.

The spin-draw machine of the present invention may be equipped with three roller sets for drawing and a take-up unit to spool the PVC filaments. The spinning filaments are first drawn between a first roller set and a second roller set. Preferably, the drawing temperature on the second roller set is in the range between 60 and 100 degrees Celsius. Thereafter, the fibers are drawn between the second roller set and a third roller set. Preferably, the temperature on the third roller set is in the range of 100 to 180 degrees Celsius. Finally, the drawn PVC filaments are wound and spooled on a take-up unit and cooled. The draw ratio at the spin-draw machine is preferably in the range of 1.8 to 2.5.

### BRIEF DESCRIPTION OF THE DRAWINGS

Further objects of the invention, together with additional features contributing thereto and advantages occurring therefrom, will be apparent from the following description of the invention when read in conjunction with the accompanying drawings; wherein:

FIG. 1 depicts a spin draw machine according to the present invention;

FIG. 2 depicts various aspects of an oil matrix coating PVC fibers manufactured according to the present invention;

FIG. 3 depicts a cross section of PVC filaments manufactured according to the present invention;

FIG. 4 depicts a cross section of PVC filaments manufactured according to conventional methods.

### DETAILED DESCRIPTION OF THE INVENTION

A process for manufacturing PVC filaments with improved characteristics is described herein. PVC filaments with uniform evenness, low elongation and shrinkage, excellent durability and lubrication, and having good formability and combability characteristics can be produced by varying the composition of PVC pellets that are subsequently spun in a conventional spin-draw machine, treated with a silicone oil, and subsequently drawn under optimal speed and temperature conditions. The PVC filaments produced in this manner are ideal for use as wig material in toy dolls. A detailed description of a preferred method for producing PVC filaments according to the invention is provided in detail below.

The PVC pellets according to the present invention are comprised of a PVC resin approximating 100 parts by weight, a stabilizing agent approximately in the range of 1 to 5 parts by weight, a lubricant approximately in the range of 0.3 to 3 parts by weight, and a processing aid approximately in the range of 0.1 to 3 parts by weight.

PVC resins are known in the art. According to a preferred embodiment of the invention, a known PVC homopolymer with a degree of polymerization approximating 500 to 1,000 is selected. In a most preferred embodiment, the degree of polymerization is approximately 800. PVC homopolymers of a polymerization degree less than 500 are not preferred because the poor filament-forming characteristics they possess. Conversely, PVC homopolymers of a degree of polymerization greater than 1,000 are deemed undesirable due to the high melting points of these resins and the attendant difficulty in obtaining a sufficient and homogenous gel upon heating.

Stabilizing agents are known in the art and may be used to stabilize the PVC resin so as to produce filaments with higher tensile strength and reduced tendency to break in the extrusion and drawing process. Stabilizing compounds according to the present invention may be selected from the group comprising cadmium (Cd), lead (Pb), and tin (Sn) compounds. In a preferred embodiment of the invention, the stabilizing agent is selected from the group comprising organic tin agents including butyl tin maleate, butyl tin laurate and butyl tin mercaptide. In a most preferred embodiment of the invention, the stabilizing agent is butyl tin maleate. The specific stabilizing agents described are not intended to limit the scope of the invention, and those skilled in the art will understand that other stabilizing agents known in the art may be used and are consistent with the scope of the present invention.

In a preferred embodiment of the invention, PVC pellets are comprised of a stabilizing agent approximately in the range of 1 to 5 parts by weight of the PVC resin. PVC pellets formulated using a stabilizing agent amount less than 1 parts by weight of the PVC resin are not preferred due to the poor heat stability, unclear color, and fragile PVC filaments that are likely to result from carbonization of the PVC gel compound. Conversely, PVC pellets formulated using a stabilizing agent amount greater than 5 parts per weight of the PVC resin is undesirable because of its tendency to result in excess stabilizing agent bleeding out from the screw, die, or nozzle during the spinning process resulting in PVC filament breakage.

In one embodiment of the invention, a lubricant as known in the art may be used in that the PVC resin composition to ensure the PVC resin may be easily released from the surface of the spin-draw machine mixer blades, cylinder, screw, and die, as well as from the nozzle of the extruder. A lubricant may also be used to control the heat of the PVC resin composition in the extruder. Lubricants known in the art that may be used consistent with the scope of the present invention include, but are not limited to esters, metal soaps, fatty acids, and hydrocarbons. A specific example of a lubricant that may be used consistent with the scope of the present invention includes polyethylene wax and stearic acid. In preferred embodiments of the present invention, the lubricant is selected from lubricant mixtures comprising an ester, a fatty acid, and a hydrocarbon lubricant.

Preferred PVC pellets utilizing lubricants and formed according to the present invention are comprised of lubricant approximately in the range of 0.3 to 3 parts by weight per 100 parts by weight of the PVC resin. PVC pellets formulated using a lubricant amount less than 0.3 parts by weight per 100 parts by weight of the PVC resin are not preferred due to the tendency of the melt polymer to stick to the metal surface of the spin-draw machine whereby the material becomes carbonized, resulting in broken PVC filaments exiting the extruder. Conversely, PVC pellets formulated using a lubricant amount greater than 3 parts by weight per 100 parts by weight of the PVC resin are undesirable because the melt polymer does not form sufficient gel such that the quantity of undrawn PVC filaments exiting the extruder drops precipitously. Furthermore, excess lubricant may result in the lubricant bleeding out from the die and from the surface of the extruder nozzle causing unstable PVC filament workability.

A processing aid may also be used according to one embodiment of the present invention. Use of a processing aid according to the invention results in stable processability and fine PVC filaments of uniform evenness. In preferred embodiments of the invention, the processing aid is added in a range approximating 0.1 to 3 parts by weight per 100 parts by weight of PVC resin. PVC pellets comprised of processing aid in amounts substantially less than 0.1 parts by weight per 100 parts by weight of the PVC resin result in an uneven release of the melt polymer from the extruder. Uneven release from the extruder results in PVC filaments that are uneven and of non-uniform size. Conversely, where the amount of the processing aid substantially exceeds 3 parts by weight per 100 parts by weight of the PVC resin, the flow of melt polymer from the extruder is unstable. A preferable example of a processing aid that may be used consistent with the scope of the present invention includes, but is not limited to methyl methacrylate.

PVC resin compositions according the present invention have been described. The PVC resin formulated according the invention is mixed in a conventional mixing apparatus prior to extrusion. In a preferred embodiment of the invention, the PVC resin composition is mixed utilizing a Hensel™ mixer. Other mixers are known in the art and may be used consistent with the scope of the present invention. According to one embodiment of the subject invention, PVC resin that has been formulated and mixed as described in the present disclosure may be compounded into pellets. The PVC pellets may be added to a conventional spin-draw machine in an amount and at such a time that PVC filaments are desired.

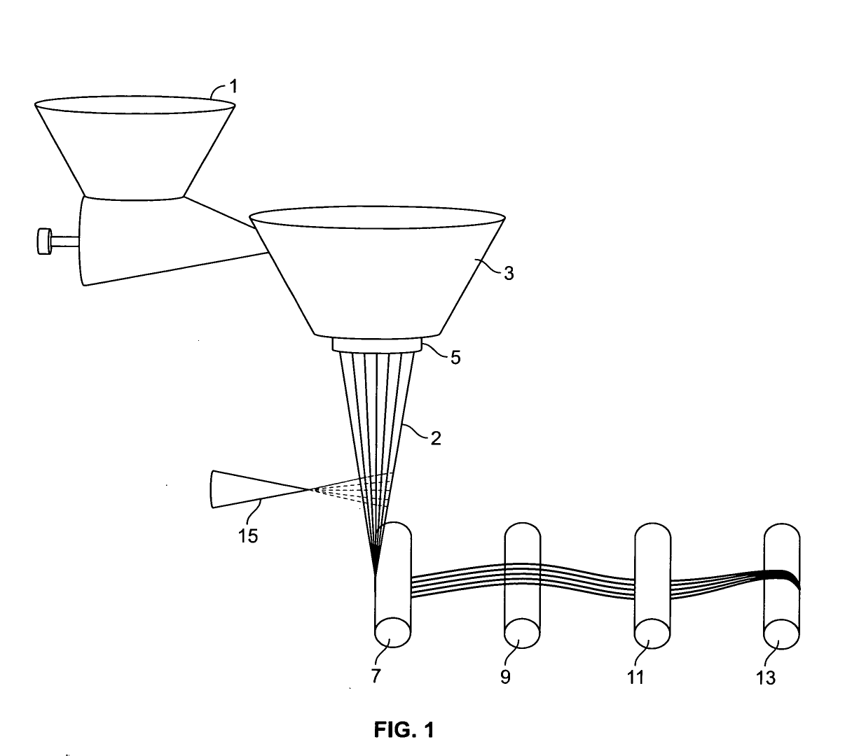

Referring now to FIG. 1, a convention spin-draw machine that may be used according to the present invention is depicted. According to one embodiment of the invention, a mixing hopper 1 accepts and mixes the PVC resins with a stabilizing agent, lubricant, or a processing aid as described. Alternatively, the hopper 1 of the spin-draw machine may accept PVC resin that has been formulated according to the present invention and previously formed into PVC resin pellets. PVC filaments exiting the hopper 1 enter the extruding cylinder 3. The PVC resin entering the extruding cylinder 3 is spun or extruded from a nozzle 5 producing undrawn PVC fiber filaments 2.

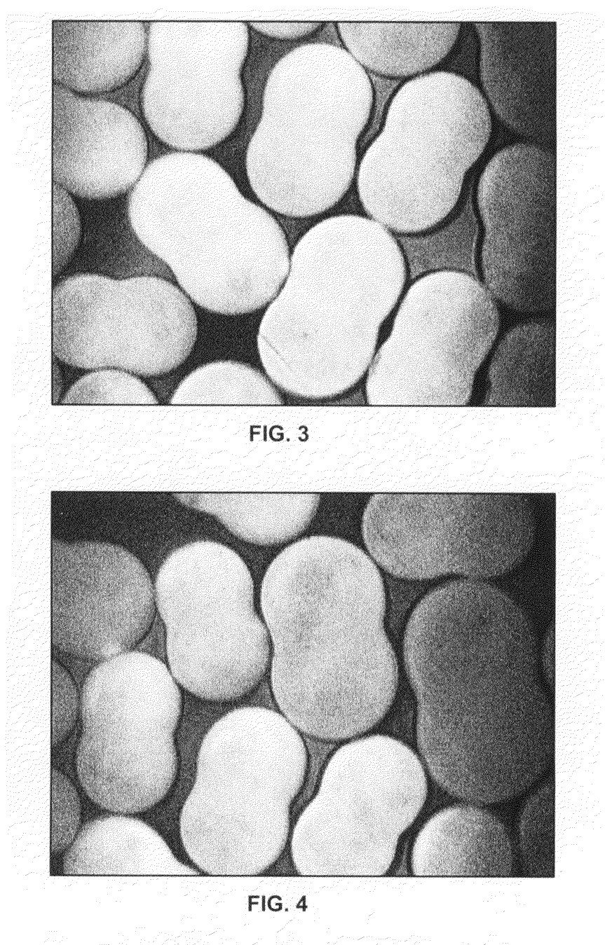

PVC fiber filament characteristics may be varied by varying extrusion parameters and by selecting a nozzle to produce filaments with the desired thickness and cross-sectional characteristics. In a preferred embodiment of the present invention, the nozzle of the extruder has a peanut shape. Referring to FIG. 3, a microscopic picture of the cross-section of PVC filaments for toy hair prepared in accordance with an example of the present invention utilizing a peanut shaped extruding nozzle is depicted. The cross-sectional dimension of the extruding nozzle will vary depending on the desired denier of the PVC filaments to be produced. In a preferred embodiment of the invention, PVC filaments are prepared to be approximately 30 to 50 denier in thickness.

A spin-draw machine utilized according to one embodiment of the present invention is equipped with a plurality of roller sets for drawing the PVC filaments and one or more take-up units. Referring again to FIG. 1, according to a preferred embodiment of the subject invention a spin-draw machine is comprised of three roller sets 7, 8, 9 and a single take-up unit 13. Each roller set may be equipped with a separate driving motor which controls the rotations per minute of each of the individual rollers. Each roller set may also be provided with a heating component to heat the filaments as they pass across or around the roller set. In an alternative embodiment of the invention, the individual roller sets may be immersed in fluid baths maintained at the desired temperature or the filaments may be heated or cooled by forced air means as the PVC filaments are drawn between the roller sets and wound on the take up unit. It will be obvious to one skilled in the art that alternative means of heating and cooling the filaments during the drawing process are consistent with the scope of the present invention.

In a preferred embodiment of the subject invention the undrawn PVC filaments are first drawn between the first roller set and the second roller set, heat-set on the third roller set and then wound up on the take-up unit. In the most preferred embodiments of the invention, the draw ratio at the spin-draw machine is preferably in the range of 1.8 to 2.5, the drawing temperature at the second roller set is approximately in the range between 60 and 120 degrees Celsius, and the heat set temperature on the third roller set is approximately in the range between 100 to 180 degrees Celsius. The heat set temperature must be carefully selected. If the heat set temperature is too low the benefits of heat setting cannot be reliably obtained. Conversely, if the heat set temperature is too high the resulting PVC filaments will have an increased tendency to stick to the surface of the rollers and the take-up unit.

The general spin-draw process of the subject invention has been described. The PVC filaments prepared through the described and equivalent spin-drawing processes according to the present invention are oil-treated. Preferably, a silicone oil is selected that is capable of forming a thin coating on the surface of the filaments. A silicone oil with a reacting group is preferred so as to result in PVC filaments for toy hair having uniform sewing characteristics and good bond adhesion characteristics for weaving. The PVC filaments that are oil treated according to the present invention also possess easy combing regardless of subsequent curling processes and good washing durability.

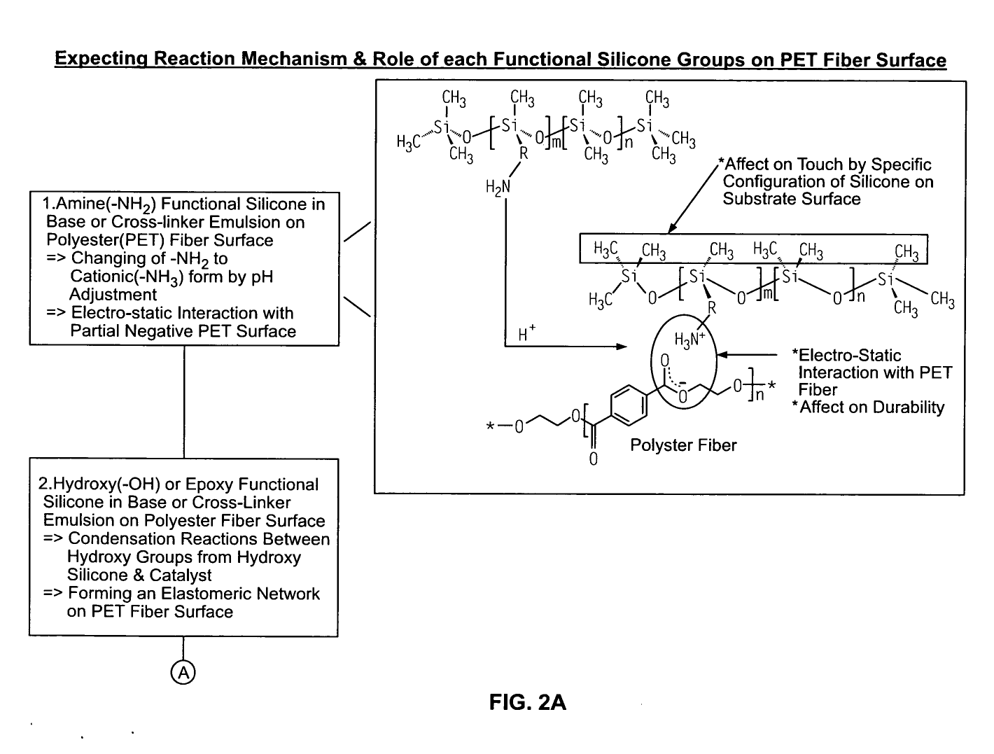

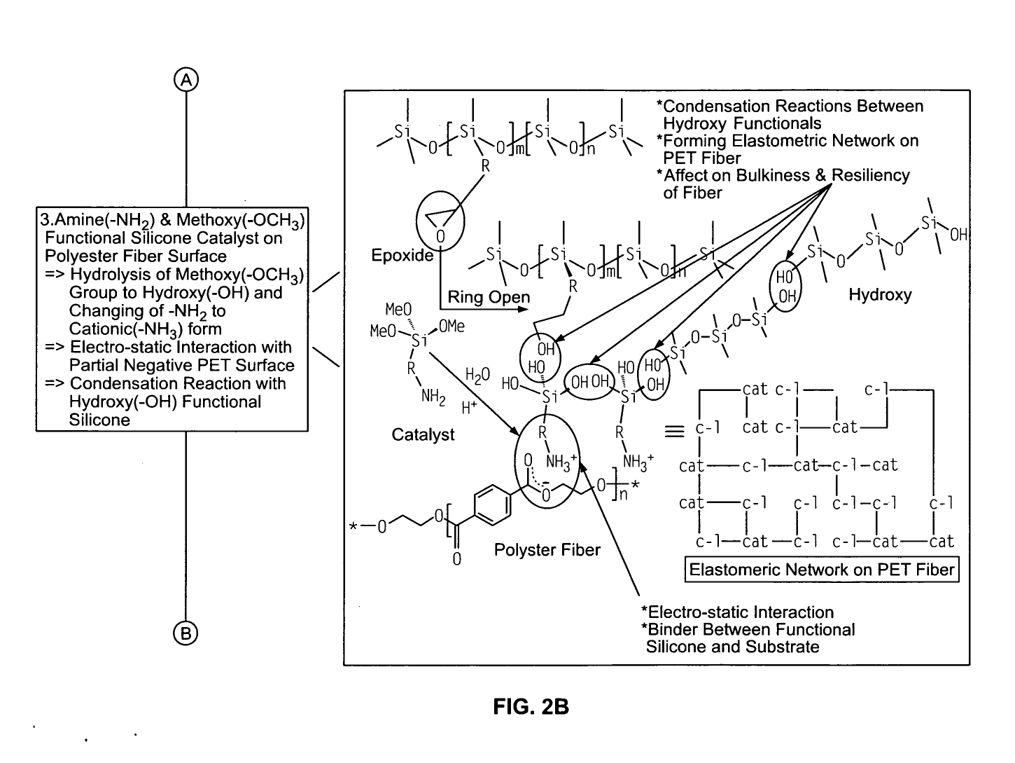

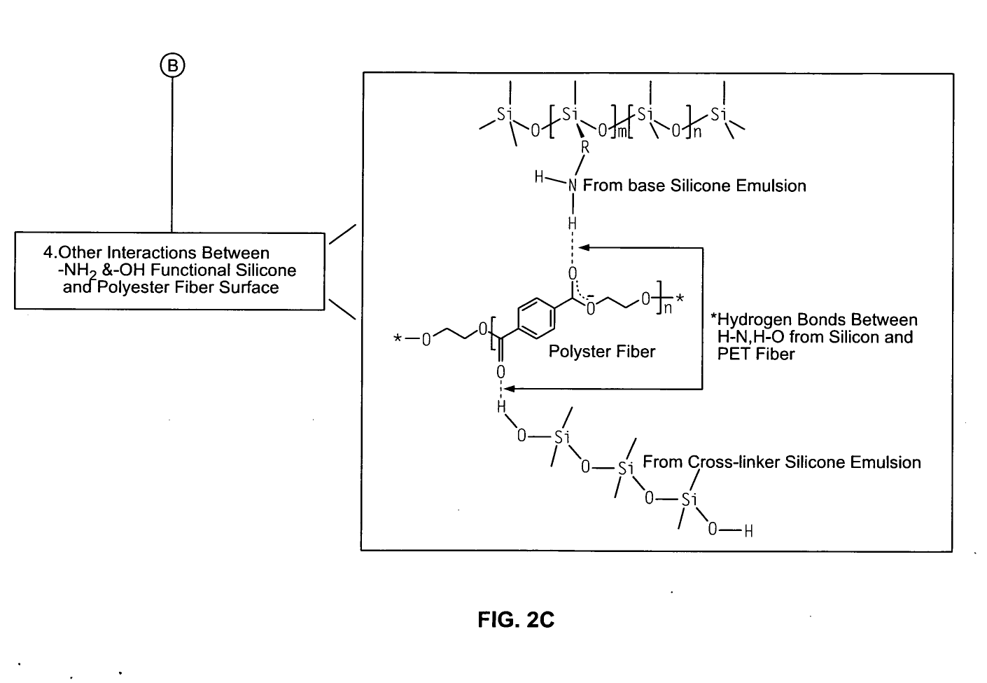

In the most preferred embodiment of the invention, oil for treating the drawn filaments in the spin-draw machine is a cross-linking type silicone oil comprising an OH-terminated polydimethyl siloxane (Component A), an amino-silicone oil (amino-modified polydimethyl siloxane) (Component B), and an epoxy silicone (Component C). Specific examples of Components A, B and C that may be used according to the present invention are depicted in FIG. 2. Components A, B and C are mixed in water in an amount approximating 1 to 3%, 0.3 to 1.5%, and 0.1 to 0.5% by weight, respectively. Oil coating of the PVC fibers according to the most preferred embodiment of the invention results in a cross-linking matrix coating the PVC filaments as depicted in FIG. 2. In an alternative embodiment of the present invention, a surfactant may also be employed in the oil composition to prevent the build up of static electricity among and between the hair fibers. Preferably, an anion surfactant such as sodium dodecyl sulfate (SDS) or sodium alkyl phosphate, or a non-ionic surfactant such as alky polyethylene oxide or alkyl propylene oxide may be used.

In a preferred embodiment of the present invention, an oil treatment unit is positioned approximately 70 to 450 centimeters below the extrusion nozzle. The oil treatment unit may be comprised of a roller touch unit or a jet spray unit. Most preferably, the oil treatment unit is comprised of a roller touch unit.

Referring to FIG. 1, a conventional spin-draw machine according to the present invention is used in conjunction with an oil treatment unit comprised of a jet spray unit 15. Undrawn PVC filaments exiting the extruder nozzle are sprayed with an oil formulation mist or shower. Preferably, the oil formulation is applied to the undrawn PVC fibers evenly and so as to completely coat the filaments while at the same time preventing waste and dripping. Alternatively, in a more preferred embodiment of the invention the undrawn PVC filaments come into physical contact with a touch roller unit that applies the oil formulation as the filaments pass across or around the touch roller. Preferably, oil treatment is evenly applied so as to completely coat the filaments without waste and dripping.

While it is most preferable to apply the oil formulation to undrawn PVC filaments exiting the extruder nozzle in the fashion described, one skilled in the art will understand that other means for applying an oil formulation may be used consistent with the scope of the present invention. For example, in one embodiment of the invention, undrawn PVC filaments may pass through a misting chamber, an oil bath, or the extrusion nozzle may be affixed with means for applying the oil directly as the filaments exit the extruder nozzle. Methods of applying the oil formulation may also be introduced between the first and second roller sets, the second and third roller sets, or at any other point intermediate in the drawing process whereby PVC filaments are drawn between a plurality of roller sets.

Descriptions of specific and preferred embodiments herein are not intended to limit the scope of the present invention and are described for the purposes of illustrating manners of practicing the present invention. The advantages and a manner of practicing the present invention will be more apparent by the following comparative examples. Comparative examples do not limit the scope of the present invention and alternative and equivalent means of practicing the present invention are within the scope and spirit of the present invention.

### COMPARATIVE EXAMPLES

PVC filaments for toy hair were prepared through a spin-draw process according to the present invention as follows:

PVC resin mixture components were measured and comprised of PVC resin with a degree of polymerization between 80 to 100 parts by weight, 3.5 parts by weight of butyl tin maleate as stabilizing agent, 0.7 parts by weight of polyethylene wax and stearic acid as lubricant, and 3 parts by weight of methyl methacrylate as processing aid. A 20 kilogram dry mixture comprised of the PVC resin mixture components was blended in a 50 l Hensel mixer to reach 110 degrees Celsius and cooled down to 50 degrees Celsius by circulating cooling water in a cooling jacket surrounding the mixer. The dry blended powder mix was fed into a PVC compounding machine available in the art to prepare PVC pellets.

A spin-draw machine for extruding undrawn PVC filaments was comprised of a 60φ single screw extruder with a compression ratio of 3.5 and with a screw of L/D of 23. The extruding nozzle was comprised of a plurality of approximately 160 peanut shaped holes, with each extruding hole having an area measurement of approximately 0.3 mm². Selected extruder temperatures of the four cylinders, C₁, C₂, C₃, C₄, the adapter and die, are 150, 175, 185, 145, 150 and 195 degrees Celsius respectively. Following set-up, undrawn PVC filaments were spun or extruded in the manner well known by those skilled in operating spin-draw machines available in the art.

A roller touch unit was utilized to oil treat undrawn PVC fibers. The oil composition was comprised of 1.7% by weight of an OH-terminated polydimethyl siloxane, 1.0% by weight of an amino-silicone oil (amino-modified polydimethyl siloxane), and 0.2% by weight of an epoxy silicone (Component C). A non-ionic surfactant was added at a quantity of 1.3% by weight in the oil composition.

The rotational speed of the roller sets were set to 130 m/min for the first, 200 m/min for the second roller, and 260 m/min for the third roller set. The take-up unit was set to wind at 260 m/min. The temperature of the second roller was set to 95 degrees Celsius and that of the third roller set to 150 degrees Celsius. Undrawn and oil treated PVC filaments are first drawn and then wound onto the take-up unit in the usual manner.

Comparative PVC filaments were produced in the following manner to demonstrate the advantages of oil treating and drawing PVC filaments according to one embodiment of the subject invention:

PVC resin pellets were produced in the same manner as the test filaments. Thereafter, undrawn PVC filaments were spun or extruded from the PVC pellets in a conventional spinning machine whose take-up speed was 130 m/min. The undrawn filaments were drawn with a conventional drawing machine with roller set temperatures set at 80 degrees Celsius and at a draw ratio of 2.0. The drawn filaments were subsequently heat-set at a temperature of 120 degrees Celsius prior to being wound on a take-up unit. The comparative PVC filaments were then compared with the test filaments prepared according to a specific embodiment of the invention.

Cross-sections of the test and comparative PVC filaments were prepared and imaged. FIG. 3 is a microscopic image obtained of cross-sections of the PVC filaments for toy hair in accordance with the test example of filaments prepared according to the present invention. FIG. 4 is a microscopic image taken at the same magnification and under the same conditions as FIG. 3 of cross-sections of PVC filaments for toy hair manufactured for comparative purposes. As shown in FIG. 4, the cross-section of the PVC filaments for toy hair in accordance with the comparative example are non-uniform in size and in shape. Conversely, as shown in FIG. 3, PVC filaments oil-treated and drawn according to one embodiment of the present invention are substantially uniform and of consistent shape and thickness.

TABLE 1 also represents comparative characteristics of the test and comparative PVC filaments according to certain tested physical properties. Comparative characteristics include: (1) evenness (U%), reported as the standard deviation of 120 yarns calculating by measuring the cross-sectional area; (2) elongation and strength, reported as a measurement of elongation and tensile strength as tested with a tensile strength tester for 5 yarns with 120 filaments; (3) heat shrinkage, reported as the shrinkage ration of 5 yarns with 120 filaments after the yarns were kept in an oven at 100 degrees Celsius for 30 minutes; and (4) combing, reported as the combability as subjectively observed by human eyes after combing 30 100 yarns with 160 filaments (◯: No tangle, □: Partial tangle, ×:Serious tangle).

TABLE 1

| Physical Properties | Example | Comparative Example |
|---|---|---|
| Evenness (U %) | 1.65 | 4.95 |
| Elongation (%) | 40 | 90 |
| Strength (g/de) | 1.1 | 1.5 |
| Heat shrinkage (%) | 5 | 10 |
| Combing ability | ∘ | Δ |

Certain advantages of the present invention will be obvious from the comparison figures and the table. The PVC filaments for toy hair according to the present invention have improved and uniform evenness, low elongation, low shrinkage, excellent durability, good curl formability and reduced tendency to tangle. Other advantages and benefits will be apparent to those skilled in the art, including advantages in formulating the PVC resin according to embodiments of the present invention.

A specific embodiment of PVC filaments manufactured according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method for producing PVC filaments comprising:
preparing PVC pellets from a PVC composition comprising a PVC resin, a stabilizing agent, a lubricant, and a processing aid;
spinning the PVC pellets in a spin-draw machine; and
extruding the spun PVC pellets to form filaments; and
oil-treating the filaments with a cross-linked silicone oil comprising an OH-terminated polydimethyl siloxane, amino-modified polydimethyl siloxane, and an epoxy silicone.

2. A method for producing PVC filaments according to claim 1, wherein the PVC pellets are comprised of a PVC resin of 100 parts by weight, a stabilizing agent of 1 to 5 parts by weight, a lubricant of 0.3 to 3.0 parts by weight, and a processing aid of 0.1 to 3.0 parts by weight.

3. A method for producing PVC filaments according to claim 1, wherein the spin-draw machine is equipped with three roller sets for drawing and a take-up unit, and the filaments being first drawn between the first roller set and the second roller set, second drawn between the second roller set and the third roller set, heat-set on the third roller set, and wound up on the take-up unit.

4. A method for producing PVC filaments according to claim 3, wherein the draw ratio at the spin-draw machine is preferably in the range of 1.8 to 2.5, and the temperature for drawing at the second roller sets is about 60 to 120 degrees Celsius, and the heat set temperature at the third roller set is preferably in the range of 100 to 180 degrees Celsius.

5. PVC filaments which are prepared by a process in accordance with claim 1.

6. PVC filaments which are prepared by a process in accordance with claim 4.

7. A PVC filament for use as doll hair comprising an extruded PVC homopolymer that is treated with a cross-linked silicone oil.

8. A PVC filament for use in doll hair according to claim 7, wherein the cross-linked silicone oil is comprised of an OH-terminated polydimethyl siloxane, amino-modified polydimethyl siloxane, and an epoxy silicone.
